(19) United States
(12) Patent Application Publication
(10) Pub. No.: US 2013/0038269 A1
(43) Pub. Date: Feb. 14, 2013

(54) HANDHELD MOBILE ELECTRICAL ASSEMBLY

(71) Applicant: Steven Stilts, Maryville, TN (US)

(72) Inventor: Steven Stilts, Maryville, TN (US)

(21) Appl. No.: 13/207,201

(22) Filed: Aug. 10, 2011

(51) Int. Cl. H02J 7/00

(52) U.S. Cl. 320/103

(57) ABSTRACT

A handheld mobile electrical assembly that includes a handheld mobile electrical device. The handheld mobile electrical device has a main body with a display, a plurality of inputs and a battery pack that powers the display and inputs. The battery pack has an exterior surface with an electrically conductive section that mates with an electrically conductive section of a carrying container that has its own separate battery pack such that the handheld mobile electrical device charges while within the carrying container. The carrying container is then recharged once the batteries in the battery pack of the carrying container run low without the need to shut off the handheld mobile electrical device that remains fully charged.

### BACKGROUND OF THE INVENTION

This invention relates to cellular telephones. More specifically, this invention relates to charging devices for cellular telephones.

Cellular and mobile telephones have been utilized by individuals for years in order to place phone calls, access the internet, and the like from remote locations from their home. Typically, cell or mobile phones contain battery packs that are able to operate the phone for a minimum period of time before the battery packs must be recharged.

In order to charge the battery pack phone chargers are provided that plug into a wall. These charges have a long wire that has a plug-in that is received by a port in the phone in order to provide electrical connection between the AC power supply and the phone batteries.

Many problems exist with this type of system. Specifically, carrying around a bulky phone charger with a power cord is not practical. Often such a phone charger is left in the drawer of a house such that when the battery of a phone runs out and needs to be charged, an individual must go all the way home in order to get the proper equipment to charge the phone. This is impractical and frustrating for a user. In addition, different phones utilize different chargers with different sized plug-ins such that if a family has multiple phones they are either forced to use the identical types of phones that can utilize the same charger or multiple chargers have to be purchased where grabbing the incorrect charger occurs. Thus, a need in the art exists for an improved method of charging cellular mobile telephones.

### BRIEF SUMMARY OF THE INVENTION

A handheld mobile electrical assembly includes a handheld mobile electrical device that has a main battery with a display and a plurality of inputs and a battery pack that is electrically connected to the main body to power the plurality of inputs and display. The battery pack has an exterior surface with an electrically conductive section. The assembly includes a carrying container that is of size and shape to receive the handheld mobile electrical device and has its own independent rechargeable battery. Within the interior of the carrying container is an electrically conductive section such that when the handheld mobile electrical device is placed within the carrying container the electrical section of the handheld mobile electrical device mates with the electrical section of the carrying container in order to provide an electrical connection such that the battery pack of the handheld mobile electrical device is charged.

### BRIEF DESCRIPTION OF THE DRAWINGS

FIG. 1 is a front perspective view of a handheld mobile electrical assembly;

FIG. 2 is a back perspective view of a handheld mobile electrical assembly;

FIG. 3 is a side plan view of an alternative embodiment of a handheld mobile electrical device; and

FIG. 4 is a side plan view of an alternative embodiment of a handheld mobile electrical device.

### DETAILED DESCRIPTION OF THE PREFERRED EMBODIMENT

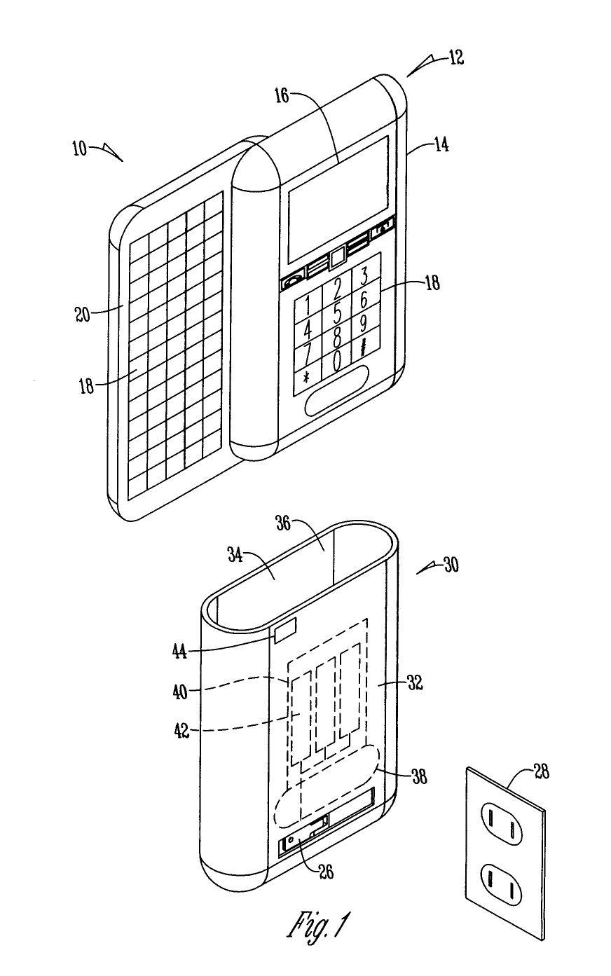

FIG. 1 shows a handheld mobile electrical assembly 10. The assembly 10 includes a handheld mobile electrical device 12 that has a main body 14 and includes a display 16 and a plurality of inputs 18 as is known in the art. The handheld mobile electrical device 12 can be any handheld mobile electrical device such as a cellular telephone, an iPad®, an iPhone®, a tablet computer or the like without falling outside the scope of this disclosure. The plurality of inputs 18 can be arranged in any manner in association with the display 16 such as directly below the display 16 or alternatively a separate keyboard that includes letters can be associated with the display 16 at a separate level as is known in the art.

A battery pack 20 is electrically connected to the main body that includes a plurality of rechargeable batteries (not shown) that are electrically connected to the main body in order to power the plurality of inputs 18 and display 16.

In one embodiment the battery pack 20 includes an exterior surface 22 that an electrically conductive section 24 that is electrically connected to the rechargeable batteries within the battery pack 20. The electrically conductive section 24 can be made of any conductive material that can provide an electrical connection to the batteries within the battery pack 20.

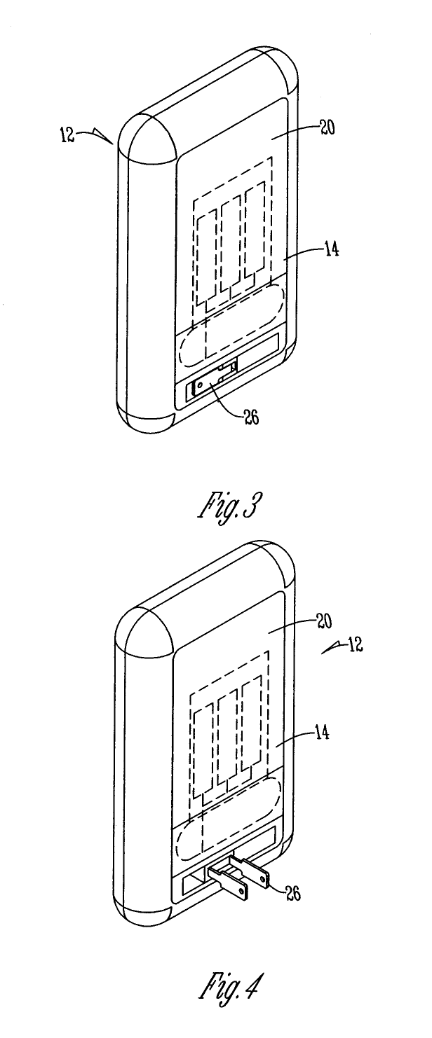

In an alternative embodiment as best shown in FIGS. 3 and 4 a set of electrical prongs 26 are pivotally connected within the battery pack 20 such that in a retracted position the set of electrical prongs 26 do not extend past the exterior surface 22 and are completely contained within the battery pack 20. The set of electrical prongs 26 when pivoted to an operable position provide an electrical connection to the batteries within the battery pack 20 such that the set of electrical prongs 26 may be directly inserted into an electrical outlet 28 to recharge the battery pack 20.

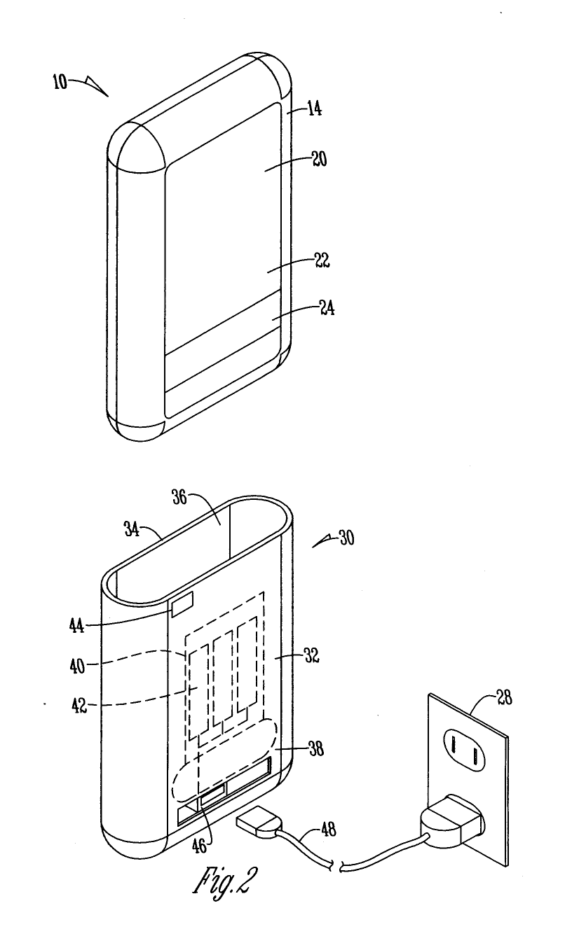

In the embodiment that is shown in FIGS. 1 and 2 where the exterior surface 22 of the battery pack 20 has an electrically conductive section 24, a carrying container 30 is provided. The carrying container 30 or carrying case can be plastic, leather, or made or any material that will provide a protective cover for the handheld mobile electrical device 12. Specifically, the carrying container 30 presents an exterior shell 32 with a hollow interior cavity 34 that is of size and shape to receive the handheld mobile electrical device 12. As best shown in FIG. 2 on an interior wall 36 of the interior cavity 34 is an electrical conductive section 38 that is electrically connected to a battery pack 40 contained within the carrying container 30.

The battery pack 40, like the battery pack 20 of the handheld mobile electrical device 12 contains a plurality of rechargeable batteries 42 that are electrically connected to an indicator window 44 that displays the amount of charge left within the rechargeable batteries 42. Thus, the carrying container 30 is designed such that when the handheld mobile electrical device 12 is inserted into the carrying container 30 the electrically conductive section 24 of the battery pack 20 aligns and provides an electrical engagement to the electrical conductive section 38 of the carrying container 30 such that the handheld mobile electrical device is charged while within the carrying container 30.

A port 46 can be disposed within the carrying container 30 such that an electrical cord 48 may be connected to the carrying container 30 and plugged into an electrical outlet 28 in order to charge the batteries 42 within the carrying container 30. Alternatively, similar to the embodiment shown in FIGS. 3 and 4, electrical prongs 26 may be pivotally attached to the battery pack 40 of the carrying container 30 to provide an electrical connection to an electrical outlet 28 in order to recharge the batteries 42 of the battery pack 40 without the use of an electrical cord.

In operation, an individual using a handheld mobile electrical device 12 uses the device for an operation. Once finished, the device is inserted into the carrying container 30 such that the electrically conductive section 38 of the carrying container 30 mates with or electrically connects with the electrically conductive section 24 on the exterior surface 22 of the battery pack 20 of the handheld mobile electrical device 12. This electrical connection causes the batteries within the handheld mobile electrical device 12 to be charged using the rechargeable batteries 42 of the carrying container 30. Thus, the handheld mobile electrical device 12 always remains in a fully charged condition. When the indicator window 44 indicates that the charge in the batteries 42 of the carrying container 30 is low, an individual may then charge the batteries 42 of the carrying container 30 either with an electrical cord 48 or the set of electrical prongs 26 that pivotally come from the carrying container 30 in order to provide an electrical connection to an electrical outlet 28 to charge the batteries 42.

Thus provided is a handheld mobile electrical assembly 10 that provides for multiple ways of charging a handheld mobile electrical device 12 without the need of utilizing cumbersome electrical cords. In addition, in an embodiment that utilizes the carrying case the handheld mobile electrical device 12 always remains in a fully charged condition. Thus, when the batteries 42 of the carrying container 30 become low, an individual does not instantly have to recharge the carrying case battery to ensure that their handheld mobile electrical device 12 is operational. Instead, an individual has the entire operating time of the batteries in the handheld mobile electrical device 12 in order to recharge the carrying container 30. Further, during this period the phone can continue to be in use and does not have to be shut down because of a low battery ensuring that phone calls, e-mails and the like are not missed during a charging phase. Thus, at the very least all of the stated objectives have been met.

What is claimed is:

1. A handheld mobile electrical assembly comprising:
a handheld mobile electrical device having a main body having a display and a plurality of inputs;
said handheld mobile electrical device having a battery pack electrically connected to the main body to power the plurality of inputs and display;
said battery pack having an exterior surface with electrically conductive section;
a carrying container of size and shape to receive the handheld mobile electrical device and having a rechargeable battery therein; and
said carrying container having an electrically conductive section such that when the handheld mobile electrical device is within the carrying container the electrically conductive section of the handheld mobile electrical device electrically connects with the electrically conductive section of the carrying container to charge the battery pack of the handheld mobile electrical device.

2. The assembly of claim 1 wherein the handheld mobile electrical device is a cellular telephone.

3. The assembly of claim 1 wherein the handheld mobile electrical device is an iPad®.

4. The assembly of claim 1 wherein the handheld mobile electrical device is a tablet computer.

5. The assembly of claim 1 wherein the carrying container has electrical prongs pivotally and electrically connected to the carrying container to provide electric current to the rechargeable battery of the carrying container.
